(19) United States
(12) Patent Application Publication
(10) Pub. No.: US 2026/0340483 A1
(43) Pub. Date: Oct. 29, 2026

(54) MACHINE LEARNING MODEL MODIFICATION USING CONFORMAL PREDICTION TECHNIQUES

(71) Applicant: Dell Products L.P., Round Rock, TX (US)

(72) Inventors: Shashank Kapoor, Agra (IN); Kailash Talreja, Mumbai (IN); Saurabh Jha, Leander, TX (US)

(21) Appl. No.: 19/189,648

(22) Filed: Apr. 25, 2025

(51) Int. Cl. G06N 20/00

(52) U.S. Cl. CPC G06N 20/00

(57) ABSTRACT

Methods, apparatus, and processor-readable storage media for enhancing machine learning model modification using conformal prediction techniques are provided herein. An example computer-implemented method includes determining uncertainty associated with at least one machine learning-generated prediction by processing the at least one machine learning-generated prediction using one or more conformal prediction techniques; detecting one or more of concept drift and data drift associated with the at least one machine learning-generated prediction based at least in part on the determined uncertainty; modifying at least a portion of at least one machine learning model associated with the at least one machine learning-generated prediction based at least in part on detecting the one or more of concept drift and data drift; and performing one or more automated actions in connection with automatically modifying the at least a portion of the at least one machine learning model.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Industries that deploy machine learning models in real-time applications face significant challenges due to the presence of concept drift and data drift. Concept drift can occur when the relationship between input features and target labels changes over time, while data drift can involve shifts in the underlying distribution of input data. These drifts can cause degradation in model performance, making it difficult to maintain the accuracy and reliability of deployed models. However, conventional machine learning approaches fail to address both concept drift and data drift, and lack mechanisms for quantifying uncertainty in model predictions, which can result in false positives, errors, and inefficient use of computing resources.

### SUMMARY

Illustrative embodiments of the disclosure provide techniques for machine learning model modification using conformal prediction techniques.

An example computer-implemented method includes determining uncertainty associated with at least one machine learning-generated prediction by processing the at least one machine learning-generated prediction using one or more conformal prediction techniques, and detecting one or more of concept drift and data drift associated with the at least one machine learning-generated prediction based at least in part on the determined uncertainty. The method additionally includes modifying at least a portion of at least one machine learning model associated with the at least one machine learning-generated prediction based at least in part on detecting the one or more of concept drift and data drift. Further, the method also includes performing one or more automated actions in connection with automatically modifying the at least a portion of the at least one machine learning model.

Illustrative embodiments can provide significant advantages relative to conventional machine learning approaches. For example, problems associated with false positives, errors, and inefficient use of computing resources arising from the lack of mechanisms for quantifying uncertainty in model predictions are overcome in one or more embodiments through automatically adapting a machine learning model-generated response associated with drift detection based at least in part on the severity of the uncertainty as determined by a corresponding conformal prediction.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for enhancing machine learning performance using conformal prediction techniques in an illustrative embodiment.

FIG. 2 shows an example workflow in an illustrative embodiment.

FIG. 3 shows example pseudocode for implementing uncertainty monitoring in an illustrative embodiment.

FIG. 4 shows example pseudocode for implementing adaptive prioritization in an illustrative embodiment.

FIG. 5 shows example pseudocode for implementing hybrid drift resolution in an illustrative embodiment.

FIG. 6 shows example pseudocode for generating confidence-aware alerts in an illustrative embodiment.

FIG. 7 shows example pseudocode for implementing post-intervention monitoring in an illustrative embodiment.

FIG. 8 is a flow diagram of a process for enhancing machine learning performance using conformal prediction techniques in an illustrative embodiment.

FIGS. 9 and 10 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

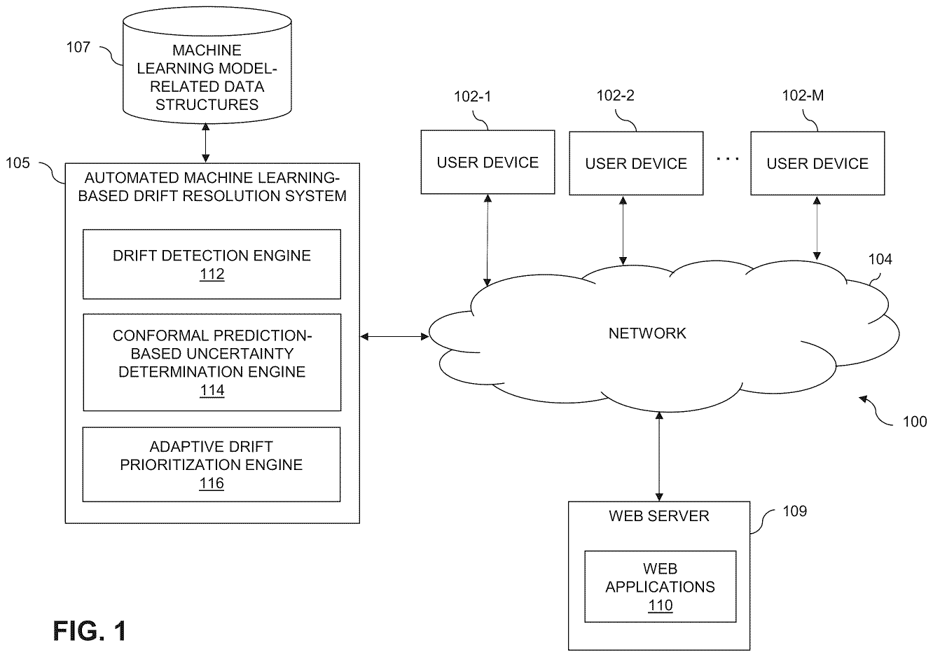

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated machine learning-based drift resolution system 105 and web server 109, upon which one or more web applications 110 (e.g., telecommunications applications, virtual assistant applications, information technology support applications, e-commerce applications, etc.) execute.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the automated machine learning-based drift resolution system 105 can have one or more machine learning model-related data structures 107 configured to store data pertaining to various internal parameters of one or more machine learning models, training information related to one or more machine learning models, prediction data associated with one or more machine learning models, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The machine learning model-related data structures 107 in the present embodiment are implemented using one or more storage systems associated with the automated machine learning-based drift resolution system 105. Such storage systems can comprise any of a variety of different types of storage including network-attached storage (NAS), storage area networks (SA Ns), direct-attached storage (DAS) and distributed DAS, as well as combinations of these and other storage types, including software-defined storage.

Also associated with the automated machine learning-based drift resolution system 105 are one or more input-output devices, which illustratively comprise keyboards, displays or other types of input-output devices in any combination. Such input-output devices can be used, for example, to support one or more user interfaces to the automated machine learning-based drift resolution system 105, as well as to support communication between the automated machine learning-based drift resolution system 105 and other related systems and devices not explicitly shown.

Additionally, the automated machine learning-based drift resolution system 105 in the FIG. 1 embodiment is assumed to be implemented using at least one processing device. Each such processing device generally comprises at least one processor and an associated memory, and implements one or more functional modules for controlling certain features of the automated machine learning-based drift resolution system 105.

More particularly, the automated machine learning-based drift resolution system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the automated machine learning-based drift resolution system 105 to communicate over the network 104 with the user devices 102, and illustratively comprises one or more conventional transceivers.

The automated machine learning-based drift resolution system 105 further comprises drift detection engine 112, conformal prediction-based uncertainty determination engine 114, and adaptive drift prioritization engine 116.

In at least one embodiment, implementing the drift detection engine 112 can include detecting concept drift and data drift within a single framework by combining one or more distribution-based methods for data drift detection and one or more relationship-based methods for concept drift detection. In such an embodiment, implementing the conformal prediction-based uncertainty determination engine 114 includes generating one or more prediction intervals for every machine learning model prediction and quantifying the uncertainty of the model's output(s). Also, in such an embodiment, implementing the adaptive drift prioritization engine 116 includes dynamically adjusting at least one machine learning model-generated response based at least in part on the severity of detected drift by leveraging the one or more prediction intervals produced by the conformal prediction-based uncertainty determination engine 114.

It is to be appreciated that this particular arrangement of elements 112, 114 and 116 illustrated in the automated machine learning-based drift resolution system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for enhancing machine learning performance using conformal prediction techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of automated machine learning-based drift resolution system 105, machine learning model-related data structures 107, and web server 109 can be on and/or part of the same processing platform.

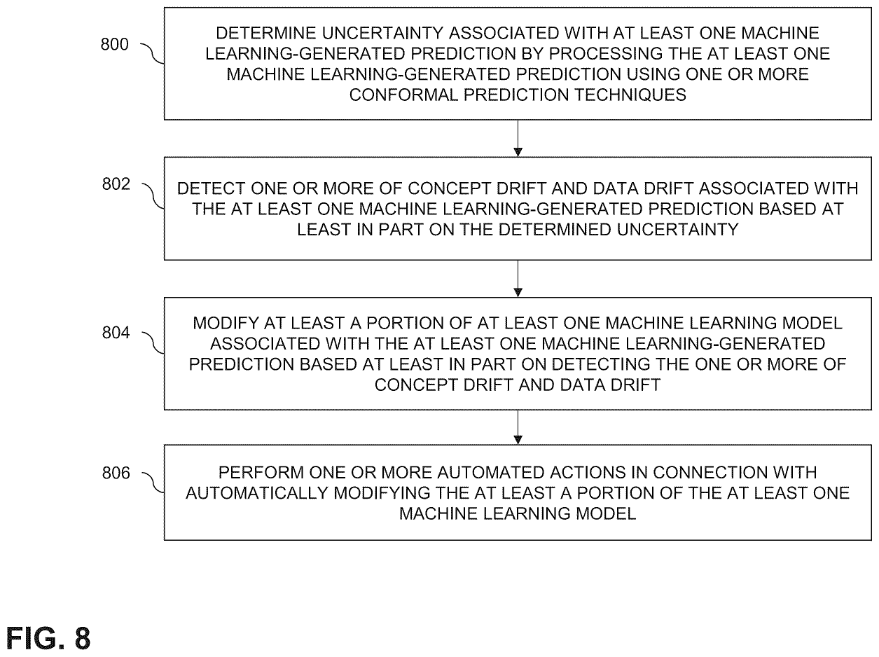

An example process utilizing elements 112, 114 and 116 of an example automated machine learning-based drift resolution system 105 in computer network 100 will be described in more detail with reference to the flow diagram of FIG. 8.

Accordingly, at least one embodiment includes enhancing machine learning performance using conformal prediction techniques. As detailed herein, such an embodiment can be applicable to multiple types of machine learning models that involve making predictions, as such models aim to determine the probability of an event occurring. In such cases, there can be a drift in the probability distribution curve, which can be addressed by one or more embodiments.

More particularly, such an embodiment can include generating and/or implementing an adaptive drift detection framework for concept drift and data drift using conformal prediction-based uncertainty processing. For example, one or more embodiments include simultaneously detecting concept drift and data drift using a unified system enhanced by conformal prediction-based uncertainty monitoring. By integrating conformal prediction into one or more detection processes, such an embodiment can include continuously monitoring prediction confidence through the generation of one or more prediction intervals. In such an embodiment, when uncertainty exceeds one or more designated thresholds, it signals one or more potential drifts, and the system can flag one or more changes in the data distribution and/or the model's relationship to the data. Based at least in part on the flagging of the one or more changes, at least one embodiment can include detecting and differentiating between drifts, facilitating a holistic approach to drift management.

Additionally, at least one embodiment includes implementing at least one dynamic drift prioritization mechanism which adapts a drift detection response based at least in part on the severity of the uncertainty as indicated by a corresponding conformal prediction. For example, when prediction confidence drops due to concept drift and/or data drift, such an embodiment can include prioritizing one or more interventions for one or both types of drifts. Such an adaptive framework enables efficient reactions to one or more machine learning model-related changes (e.g., one or more critical changes) while ignoring minor fluctuations, reducing false positives and enhancing model performance across multiple applications. Accordingly, and as further detailed herein, a hybrid drift resolution framework provides a comprehensive response to drift, combining data-driven and relationship-based drift detection.

By leveraging one or more confidence-aware interventions and dynamically adjusting to varying data characteristics, one or more embodiments include maintaining machine learning model performance in dynamic environments. Also, the integration of conformal prediction-based uncertainty provides the ability to measure and track the reliability of model predictions, rendering the framework more robust and scalable, particularly with respect, for example, to contexts and uses cases facing the complexities of evolving data streams and model decay.

At least one embodiment includes autonomously and continuously monitoring predictions of at least one machine learning model and the one or more corresponding input data streams for one or more signs of drift. More particularly, such an embodiment can include measuring prediction uncertainty (e.g., in real time) using conformal prediction techniques, which facilitates the early and reliable detection of drifts. The integration of conformal prediction techniques enables the system to provide one or more prediction intervals, enabling confidence assessments of the model's predictions and triggering drift detection when at least one of the intervals widen beyond one or more designated thresholds.

As further detailed herein, at least one embodiment includes implementing at least one unified drift detection engine, which detects concept drift and data drift within a single framework. The at least one unified drift detection engine combines one or more distribution-based methods for data drift detection and one or more relationship-based methods for concept drift detection, ensuring comprehensive drift detection.

Also, one or more embodiments include implementing at least one conformal prediction-based uncertainty determination engine, which generates one or more prediction intervals for every machine learning model prediction, quantifying the uncertainty of the model's output(s). As prediction intervals widen, the at least one conformal prediction-based uncertainty monitoring engine can signal an increased likelihood of drift, facilitating early detection of machine learning model performance degradation.

Additionally, at least one embodiment includes implementing at least one adaptive drift prioritization mechanism, which dynamically adjusts at least one response based at least in part on the severity of detected drift by leveraging the one or more prediction intervals produced by conformal prediction. In one or more embodiments, drifts causing large uncertainty increases are prioritized, ensuring that the system can react first to the most critical drifts and can ignore minor and/or non-impactful changes.

Accordingly, at least one embodiment includes implementing a hybrid drift resolution framework. In such an embodiment, once a drift is detected, the framework employs a hybrid approach that integrates one or more data-driven interventions (e.g., for detected data drift) and model retraining and/or recalibration (e.g., for detected concept drift). The hybrid framework ensures an appropriate automated action in response to detected drift depending at least in part on the type and severity of the detected drift. By combining conformal prediction with adaptive drift detection and prioritization, such an embodiment includes providing a reliable and resource-efficient approach to manage machine learning model degradation due to concept drift and data drift (e.g., in contexts relying on machine learning models in one or more dynamic environments).

As detailed herein, one or more embodiments include applying one or more targeted interventions based on detected drift type (e.g., whether the detected drift is categorized as concept drift or data drift), thus enhancing resource usage and reducing unnecessary model retraining, which can reduce operational costs and complexity.

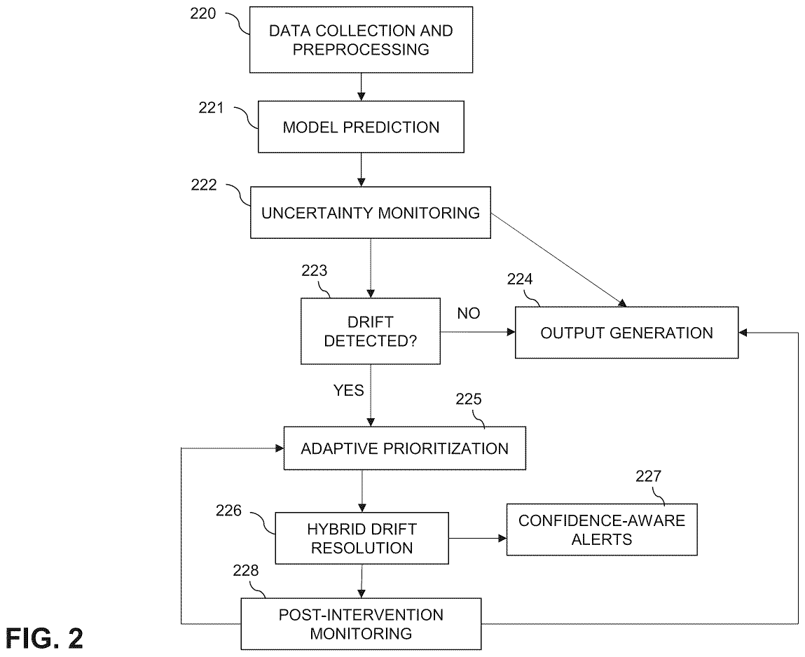

FIG. 2 shows an example workflow in an illustrative embodiment. By way of illustration, and as depicted in FIG. 2, step 220 includes data collection and preprocessing, step 221 includes generating at least one model prediction, step 222 includes performing uncertainty monitoring, and step 223 includes performing drift detection (e.g., determining whether any drift is detected in connection with the uncertainty monitoring). If no drift is detected in the at least one model prediction, then step 224 includes generating the output associated with the at least one model prediction. If drift is detected in the at least one model prediction, then step 225 includes performing adaptive prioritization in connection with the at least one model prediction.

Further, step 226 includes performing hybrid drift resolution, which can also include generating one or more confidence-aware alerts in step 227. Additionally, step 228 includes performing post-intervention monitoring, followed by output generation in step 224.

In connection with data collection and preprocessing, the system collects and prepares data for a given deployed machine learning model to facilitate accurate drift detection and model predictions. More particularly, the system gathers data from various sources relevant to the deployed machine learning model (e.g., sensor data in an industrial setting, transactional data in financial systems, user activity data from web applications, etc.). At least a portion of the collected data is then preprocessed to ensure it is in a format suitable for input into the machine learning model and the drift detection system. Such preprocessing tasks can include, for example, imputation of missing values to ensure completeness of the dataset, adjusting numerical values to a consistent scale, ensuring that features with larger magnitudes do not disproportionately affect the model, converting categorical variables into numerical formats (e.g., using one-hot encoding) that the machine learning model can process and/or understand, and identifying and handling outliers that may distort the machine learning model's understanding of the data.

As detailed in connection with FIG. 2, one or more embodiments include generating model predictions. M ore particularly, after the data is collected and preprocessed, the preprocessed data is fed into the trained machine learning model, which generates predictions based on the input features. Depending on the nature of the model, these predictions can be, e.g., classification labels, regression outputs, and/or other types of inferences. For example, in a classification task, the model outputs a class label (e.g., “fraud” or “not fraud”), while in a regression task, the model might output a continuous value (e.g., predicting the future price of a stock).

A long with the prediction(s), the machine learning model can also provide at least one measure of confidence and/or at least one probability score associated with the prediction. For example, in classification tasks, SoftMax probabilities indicate the likelihood of each class, showing how confident the model is in its output.

Also, in at least one embodiment, one or more conformal prediction techniques are applied to generate prediction intervals and/or confidence scores that quantify the model's uncertainty. These intervals help determine the level of confidence in the prediction and play a role in uncertainty monitoring for drift detection. Accordingly, in such an embodiment, a prediction is output along with a measure of how certain the model is about that prediction. This prediction is then analyzed further, as detailed below, for indications of concept drift and/or data drift.

As also detailed in connection with FIG. 2, one or more embodiments include performing uncertainty monitoring, which leverages conformal prediction to monitor the uncertainty in the machine learning model's predictions. Such an embodiment can include tracking changes in the model's confidence over time and using this information to identify potential concept drift and/or data drift (e.g., before model performance significantly degrades). As used herein, conformal prediction refers to a statistical framework that provides one or more prediction intervals and/or confidence bounds for each prediction made by a given machine learning model. Such intervals represent the range within which the true value is expected to lie with a certain probability (e.g., 95% confidence). For example, if the machine learning model predicts that a user will spend $100, conformal prediction might produce an interval of $80 to $120, meaning that the true value is expected to fall within this range with 95% confidence.

After the machine learning model generates a prediction for an input, one or more embodiments can include applying conformal prediction to generate a prediction interval around the output. The size (e.g., the width) of this interval reflects the model's uncertainty: a narrow interval indicates high confidence, while a broad and/or wide interval suggests greater uncertainty in the prediction. Such intervals are calculated dynamically for each new prediction, providing real-time insight into how the model's uncertainty evolves as new data is processed.

Additionally, one or more embodiments include continuously monitoring the size (e.g., the width) of the prediction intervals over time to detect one or more trends that may indicate drift. For instance, a significant increase in the width of prediction intervals can be a sign that the corresponding machine learning model is becoming less confident in its predictions, potentially due to changing data patterns and/or relationships (i.e., concept drift and/or data drift). By way of example, if the intervals start to widen suddenly for a particular subset of the data, this might suggest that the data distribution has shifted (e.g., data drift), and/or that the relationship between features and the output has changed (e.g., concept drift).

Accordingly, at least one embodiment includes using one or more predefined uncertainty thresholds to assess when a change in prediction interval width is significant enough to indicate drift. If the uncertainty exceeds such thresholds, it triggers further drift analysis and possible intervention. In such an embodiment, such thresholds are adaptive, meaning that the thresholds can be adjusted based at least in part on the machine learning model's performance history and/or one or more specific requirements of the application. For instance, a more critical application might have stricter thresholds for uncertainty increases.

Also, by catching drift early and/or preemptively, one or more embodiments can include initiating corrective actions before the drift severely impacts the machine learning model's accuracy, ensuring more reliable and continuous performance in production environments.

As additionally detailed herein, at least one embodiment can include categorizing uncertainty-related drift. With respect to concept drift, if the relationship between input features and the target output has changed, the model's predictions might become less reliable even if the input data distribution remains the same. This can be reflected in increasing uncertainty around one or more certain features and/or regions of the data. With respect to data drift, if the distribution of the input data itself changes (e.g., new data points are very different from what the machine learning model was trained on), this can also lead to increased uncertainty. At least one embodiment can include detecting such shifts by observing widening prediction intervals across various features and/or data subsets.

By way of example, consider a predictive maintenance system for industrial machinery that predicts the likelihood of machine failure based on sensor data. Over time, the machine's usage patterns change, but the machine learning model continues to generate predictions. The system predicts that a machine will not fail within the next 30 days and generates a confidence interval around this prediction (e.g., a 95% prediction interval that the likelihood of failure is between 2% and 10%). Over time, as new data from the machine's sensors is collected, the system notices that the prediction intervals start to widen; for example, the interval might change from between 2% and 10% to between 2% and 20%, indicating increased uncertainty in the machine learning model's prediction. This widening of the interval suggests that the machine's usage patterns and/or sensor readings have changed, signaling potential drift. The system's uncertainty monitoring component triggers further analysis to investigate whether concept drift (e.g., a change in the machine's behavior) and/or data drift (e.g., a change in sensor data patterns) is responsible.

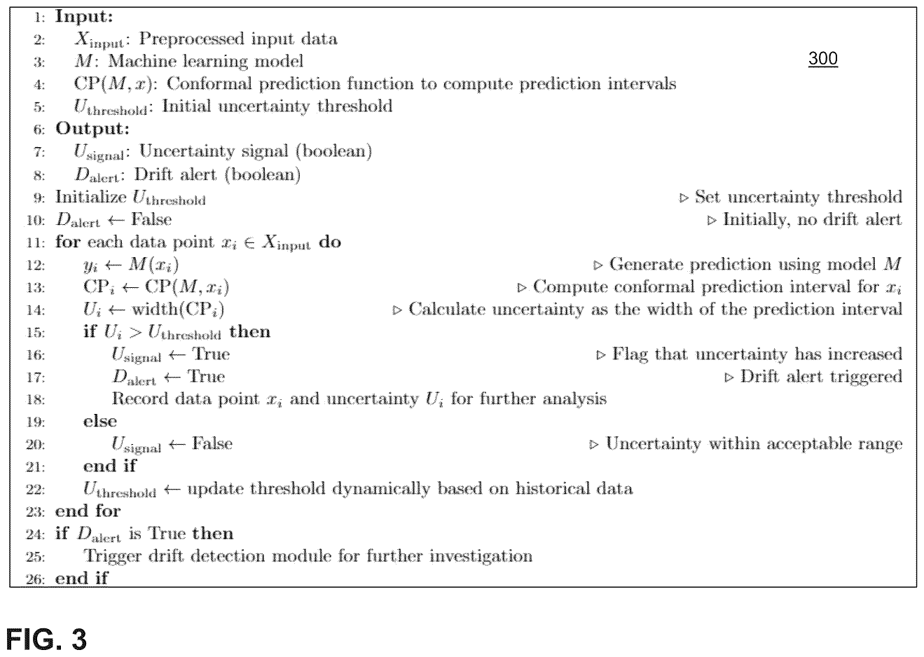

FIG. 3 shows example pseudocode for implementing uncertainty monitoring in an illustrative embodiment. In this embodiment, example pseudocode 300 is executed by or under the control of at least one processing system and/or device. For example, the example pseudocode 300 may be viewed as comprising a portion of a software implementation of at least part of automated machine learning-based drift resolution system 105 of the FIG. 1 embodiment.

The example pseudocode 300 illustrates a model generating predictions on incoming data points, and conformal prediction intervals being calculated for each prediction. The width of the prediction interval is used to measure the uncertainty of each prediction, and if the uncertainty exceeds a designated threshold, an uncertainty signal is raised and a drift alert is triggered, flagging potential drift and further drift detection and analysis. The uncertainty threshold is updated dynamically based at least in part on historical data and/or current data.

In implementing uncertainty monitoring, at least one embodiment includes applying conformal prediction techniques to generate prediction intervals, and continuously monitoring the uncertainty associated with the machine learning model's predictions. Any significant changes in uncertainty are used as early indicators of drift. By tracking the widening of prediction intervals and using adaptive uncertainty thresholds, such an embodiment can include detecting and categorizing concept drift and/or data drift in real time, ensuring that the machine learning model remains accurate and reliable despite evolving data.

It is to be appreciated that this particular example pseudocode shows just one example implementation of uncertainty monitoring, and alternative implementations can be used in other embodiments.

As also detailed in connection with FIG. 2 and elsewhere herein, one or more embodiments include implementing drift detection, which includes identifying concept drift and/or data drift by analyzing a machine learning model's prediction behavior and the distribution of input data. Such an embodiment includes using conformal prediction-based uncertainty along with one or more statistical tests to detect shifts in data distribution and/or relationships between input features and target variables. Additionally, drift detection can be performed by simultaneously monitoring for both concept drift and data drift, utilizing a unified drift detection engine. This step can serve as an important part of an adaptive drift detection framework, as it facilitates identification when the machine learning model is facing deteriorating performance due to changes in the data.

As noted herein, concept drift refers to at least one change in the relationship between one or more input features and one or more target labels. This type of drift can occur when the machine learning model's learned associations between features and the output no longer hold due to evolving patterns in the environment and/or system behavior. Also, data drift refers to one or more changes in the distribution of the input data itself. This could happen, for example, if one or more new patterns emerge in the data that were not present during the machine learning model's training phase.

At least one embodiment includes continuously monitoring relationships between input features and the model's predictions. If the predictive relationships between features and the target output begin to change, this can be an indicator of concept drift. In connection with conformal prediction-based uncertainty monitoring, as the relationships between features and predictions degrade, the prediction intervals can widen, indicating increased uncertainty that represents early indicators of concept drift.

Additionally, in one or more embodiments, data drift detection can include distribution-based monitoring and one or more statistical tests. M ore particularly, such an embodiment includes continuously monitoring one or more statistical properties of the input data's distribution. Changes in the distribution of features (e.g., the mean, variance, or other moments of the data) can signal data drift. Further, such an embodiment can include using one or more distribution-based methods, such as Kullback-Leibler (KL) divergence, Kolmogorov-Smirnov (K-S) tests, and/or two-sample t-tests, to compare the incoming data distribution with the original training data distribution, wherein significant differences in distributions can indicate data drift.

Also, at least one embodiment includes employing one or more adaptive thresholds for drift detection. Such thresholds can be adjusted dynamically based at least in part on the current uncertainty levels produced by conformal prediction. As the uncertainty in predictions grows, the thresholds are adjusted to capture significant changes, reducing false positives and ensuring that only meaningful drifts trigger alerts.

In one or more embodiments, adaptive thresholds can grow tighter or looser depending on the incoming data patterns and prediction confidence values. If uncertainty remains low, the thresholds are more lenient, avoiding unnecessary interventions. As uncertainty increases, the thresholds tighten, allowing the system to catch more significant drift events.

When increased uncertainty and/or distributional shifts are detected, a drift alert can be triggered, and depending on the nature of the drift, at least one embodiment includes determining whether the drift is concept drift (e.g., relationship-based) or data drift (e.g., distribution-based). Additionally, the detected drift can be prioritized based at least in part on its severity, which can be determined by the degree of uncertainty increase and its impact on predictions.

As detailed herein, concept drift occurs when the relationship between the features X=[X₁, X₂, . . . , X_{d}] and the target variable Y changes over time. This can be formally represented as a change in the conditional probability distribution as follows: P(Y|X)=P(Y|X₁, X₂, . . . , X_{d}).

The system uses conformal prediction to generate prediction intervals as follows: CPₜ=[ [symbol] , [symbol] ]. Also, the width of the prediction interval measures the uncertainty as follows: Uₜ= [symbol] − [symbol] . When the uncertainty Uₜ consistently exceeds a designated threshold U_{threshold}, this indicates that the model's confidence in its predictions has dropped, signaling potential concept drift.

Another indicator of concept drift can include a change in feature importance. For example, let βᵢ represent the coefficient (importance) of feature Xᵢ in the model, and significant changes in βᵢ over time may indicate concept drift as follows: |β_{i,t}_{₁}, β_{i,t}_{₂}|>δ_{threshold} for some i. Here, δ_{threshold} represents a threshold for significant changes in feature importance.

To detect data drift, one or more embodiments include comparing the distributions, Pₜ_{₁}(X)≈Pₜ_{₂}(X) for t₁≠t₂ at different time points. Also, in such an embodiment, the KL divergence measures how much the input data distributions have diverged, and a significant increase in KL divergence (ϵKL) can indicate data drift, such as follows:

$${D}_{KL} ( {P}_{{t}_{1}} ( X ) ‖ {P}_{{t}_{2}} ( X ) ) ‖ = \int {P}_{{t}_{1}} ( X ) log ( \frac{{P}_{{t}_{1}} ( X )}{{P}_{{t}_{2}} ( X )} ) dX .$$

Additionally or alternatively, the K-S test compares two cumulative distribution functions (CDFs) at time points Fₜ_{₁}(X) and Fₜ_{₂}(X), and the test statistic D_{KS} captures the maximum difference between the two CDFs as follows: D_{KS}=supₓ|Fₜ_{₁}(X)−Fₜ_{₂}(X)|. A large D_{KS} value can indicate that the data distributions are different, signaling potential data drift.

As detailed in connection with FIG. 2 and elsewhere herein, one or more embodiments include implementing an adaptive prioritization mechanism that ranks detected drifts based at least in part on their severity and potential impact. Accordingly, such an embodiment includes facilitating the efficient allocation of resources towards the most critical drifts, while deprioritizing minor and/or non-impactful drifts. This step introduces at least one layer of intelligence into the drift detection process, enabling dynamically adjustment of its response based on real-time data.

In at least one embodiment, a severity score can be determined using multiple factors, including, for example, the extent of change in the model's predictive relationships (for concept drift) or data distributions (for data drift), the increase in prediction uncertainty, as indicated by the widening of conformal prediction intervals, and the magnitude of deviation from the model's expected behavior (for concept drift) or expected data distribution (for data drift).

Additionally, one or more embodiments can include dynamically adjusting based on drift type. More particularly, such an embodiment can include dynamically adjusting a prioritization approach based on whether the detected drift is concept drift or data drift. If a concept drift is detected, at least one embodiment includes determining how drastically the model's predictions have been impacted and how much uncertainty has increased. Concept drift is often more critical because it indicates that the model's understanding of the underlying problem is no longer valid. In an example embodiment, high-severity concept drifts receive the highest priority.

For data drift, at least one embodiment includes assessing how much the distribution of input data has changed compared to the original training data. If the change is severe (e.g., new data points are very different from what the model was trained on), the drift is prioritized. Moderate data drift may not require immediate action if the model can still generalize well, but if the drift starts causing prediction uncertainty, it may be escalated in priority.

If both data drift and concept drift occur together, at least one embodiment includes evaluating the combined effect of the drifts. For example, a high degree of data drift combined with increased prediction uncertainty suggests a high-priority event requiring urgent and/or immediate action.

Also, one or more embodiments can include operating in a feedback loop, which includes continuously monitoring the results of drift interventions (if applied) and adjusting the prioritization process based at least in part on real-time performance data. If a drift was deprioritized but later worsens or causes issues, the system can escalate its priority and trigger a more immediate response. Further, such an embodiment includes learning from past interventions, fine-tuning a prioritization mechanism to improve accuracy and efficiency over time.

Further, in at least one embodiment, low-severity drifts (e.g., drifts that do not significantly affect model accuracy or uncertainty) can be automatically deprioritized. Such an embodiment can include continuing to monitor such drifts but without triggering costly and/or unnecessary interventions (e.g., such as model retraining).

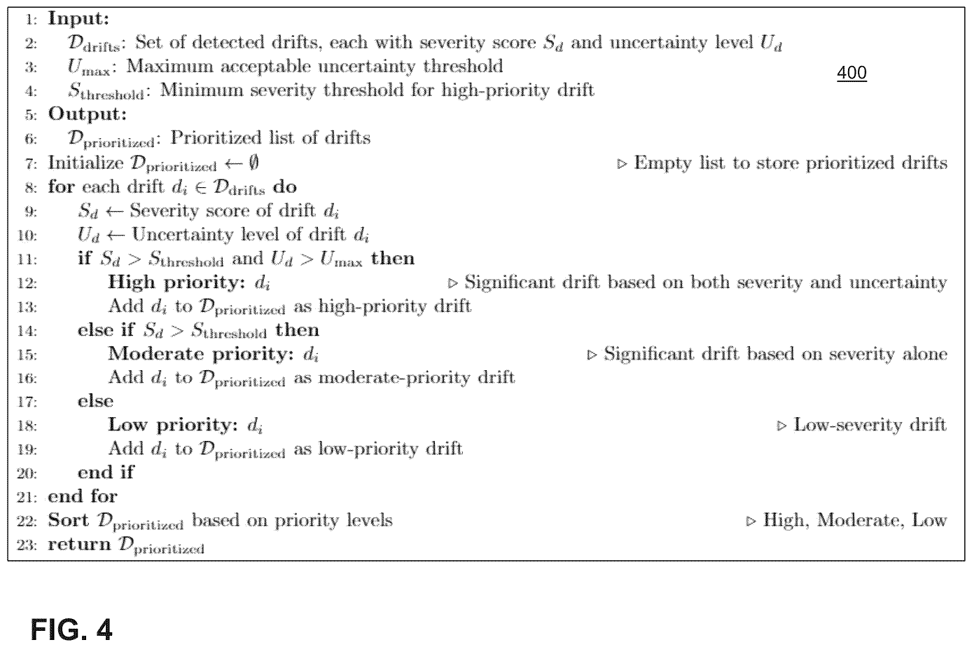

FIG. 4 shows example pseudocode for implementing adaptive prioritization in an illustrative embodiment. In this embodiment, example pseudocode 400 is executed by or under the control of at least one processing system and/or device. For example, the example pseudocode 400 may be viewed as comprising a portion of a software implementation of at least part of automated machine learning-based drift resolution system 105 of the FIG. 1 embodiment.

The example pseudocode 400 illustrates adaptive prioritization, wherein detected drifts are evaluated and prioritized based at least in part on their severity and uncertainty. Drifts with high severity and high uncertainty can be ranked higher, allowing efficient allocation of resources to the most critical drifts. Such an approach facilitates dynamic adaptation to evolving data conditions and ensures that resources are not wasted on minor drifts while addressing critical issues promptly.

It is to be appreciated that this particular example pseudocode shows just one example implementation of adaptive prioritization, and alternative implementations can be used in other embodiments.

As detailed in connection with FIG. 2 and elsewhere herein, one or more embodiments include implementing a hybrid drift resolution framework that effectively addresses the specific type of drift detected (e.g., concept drift and/or data drift) using one or more tailored interventions. This step is designed to restore the performance of the machine learning model by automatically selecting the appropriate resolution mechanism based at least in part on the nature of the drift and its severity. Such a hybrid approach ensures that both data-driven and relationship-based interventions are applied correctly to resolve drift efficiently.

Concept drift, if left unaddressed, can lead to significant model performance degradation because, for example, the model's internal understanding of the problem may no longer align with the current reality. Accordingly, and as further described herein, one or more embodiments include addressing concept drift through a combination of relationship-based adjustments and model recalibration.

For example, when concept drift is detected, such an embodiment can include initiating model recalibration, adjusting one or more of the model's internal parameters without fully retraining the model. This can involve, for instance, updating the model's weights, feature importance, and/or decision boundaries based at least in part on newly observed data, ensuring that the model reflects the changed relationships between input features and outcomes. Additionally or alternatively, at least one embodiment can include analyzing changes in feature relationships and suggesting and/or automatically implementing one or more feature engineering adjustments. This may include, for example, creating one or more new features that better capture the evolved patterns and/or transforming one or more existing features to reflect the updated relationships.

In cases wherein recalibration or feature adjustments are not sufficient to resolve the concept drift, at least one embodiment can include triggering partial retraining of the model on new and/or recent data. A partial retraining process can be more efficient than full model retraining, as partial retraining focuses on the parts of the model that are affected by the drift.

As also detailed herein, data drift occurs when the distribution of input data shifts over time. If input data no longer matches the training distribution, the model's predictions may become inaccurate. Accordingly, one or more embodiments include resolving data drift by applying one or more data-driven interventions, ensuring that the model can adapt to new data without requiring a complete overhaul. For instance, such an embodiment can include checking for changes in feature distributions and adjusting one or more data preprocessing steps accordingly. This might involve, for example, recalibrating normalization, scaling, and/or binning techniques to ensure that the model receives data in the correct range and/or format.

Additionally or alternatively, at least one embodiment can include applying one or more adaptive transformations to incoming data to align the data with the original training data distribution. Techniques such as, e.g., principal component analysis (PCA) and/or data imputation can be used to reduce the impact of data drift on the model's predictions. Also, for severe data drift, wherein the feature distributions have shifted significantly, at least one embodiment can include initiating targeted retraining using the affected portions of the data. This can ensure that the model learns from the new distribution patterns and adapts to the changes without requiring a full retrain.

In some cases, both concept drift and data drift may occur simultaneously, requiring a hybrid approach to resolve the issues. In such a scenario, one or more embodiments include intelligently combining relationship-based and data-driven interventions to restore model performance. For example, such an embodiment can include recalibrating one or more model parameters and then adjusting the data preprocessing pipeline. Such a joint intervention can ensure that the model can handle both changes without overfitting to one aspect. Additionally or alternatively, if both types of drift are significant and the above-noted interventions are insufficient, one or more embodiments can include triggering a full model retraining on newly collected data.

Also, after any intervention (whether recalibration, feature adjustment, retraining, etc.), at least one embodiment includes initiating a feedback loop which includes continuously monitoring the model's performance. More particularly, such an embodiment can include monitoring the model's accuracy, uncertainty, and performance metrics after the intervention(s). If the drift resolution has been successful, the model's uncertainty will decrease, and performance metrics will return to expected levels. If performance does not improve or worsens, such an embodiment includes re-evaluating the intervention(s) and adjusting one or more portions of the applied solution accordingly. Further, one or more embodiments include learning from past interventions, and using such information to fine-tune future drift detection and resolution strategies. For example, if a certain resolution technique (e.g., recalibration or partial retraining) proves effective for a specific type of drift, such an embodiment can include prioritizing that approach when a similar drift is detected in the future.

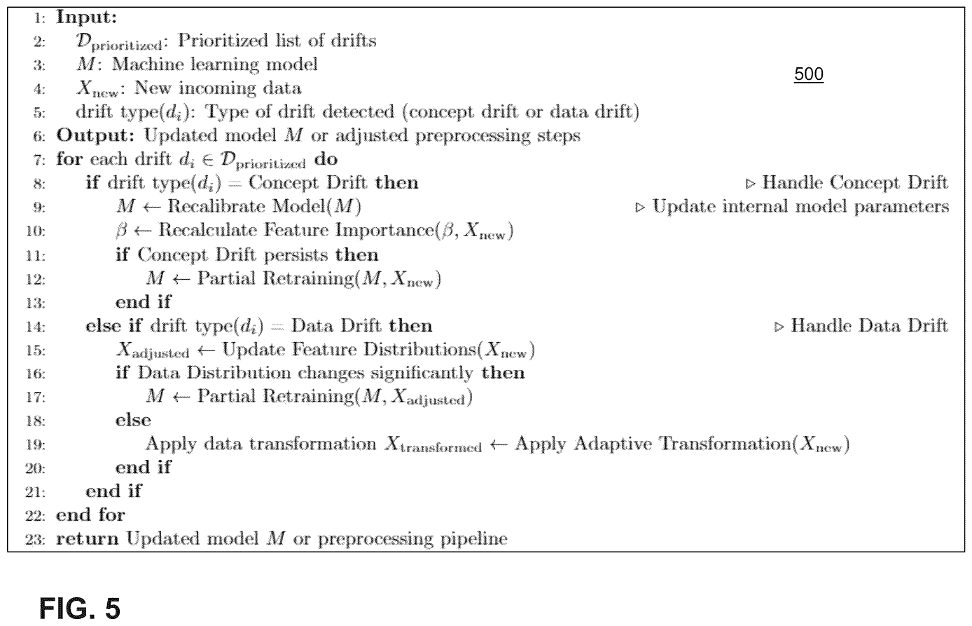

FIG. 5 shows example pseudocode for implementing hybrid drift resolution in an illustrative embodiment. In this embodiment, example pseudocode 500 is executed by or under the control of at least one processing system and/or device. For example, the example pseudocode 500 may be viewed as comprising a portion of a software implementation of at least part of automated machine learning-based drift resolution system 105 of the FIG. 1 embodiment.

The example pseudocode 500 illustrates an example hybrid drift resolution algorithm. By way of illustration, consider an example hybrid drift resolution use case wherein a loan approval model is used by a bank to predict the likelihood of loan defaults, and wherein over time, both concept drift (e.g., changes in customer behavior) and data drift (e.g., new demographic data being introduced) are detected. M ore particularly, it is detected that the relationship between customer credit scores and default likelihood has changed, wherein customers with lower scores are now defaulting at a higher rate than predicted. At least one embodiment, as shown in example pseudocode 500, can then include recalibrating the model to give more weight to recent payment history and less to credit score alone, adjusting the feature importance.

Also, it is further detected that a significant number of younger customers with different income levels have started applying for loans. Accordingly, as also shown in example pseudocode 500, such an embodiment includes adjusting the preprocessing steps to normalize this new income range and applying partial retraining to account for the new demographic data. Consequently, such an embodiment includes combining these two interventions (i.e., recalibrating the relationship between credit score and default likelihood, and updating the data distribution for the new customer demographics), and after applying the changes, the model's performance is monitored for improvement and/or uncertainty reduction.

It is to be appreciated that this particular example pseudocode shows just one example implementation of hybrid drift resolution, and alternative implementations can be used in other embodiments.

Referring again to FIG. 2, and as also further detailed herein, one or more embodiments include generating data-driven confidence-aware alerts when drift is detected. Such alerts provide detailed, confidence-based insights into the drift, enabling users to understand the severity, certainty, and impact of the detected drift. Also, as detailed herein, conformal prediction-based uncertainty monitoring plays a pivotal role in determining confidence in the detected drift, ensuring that false positives are reduced and/or minimized, and that alerts are triggered for drifts that are statistically significant and impactful. More particularly, one or more embodiments include implementing conformal prediction to generate prediction intervals for each model prediction, and these intervals represent the model's level of uncertainty in its prediction (e.g., the wider the interval, the greater the uncertainty in the model's output). Accordingly, when drift is detected, such an embodiment also includes examining corresponding prediction intervals and using such intervals to assign a confidence score to the drift detection event.

Further, once a drift is detected, at least one embodiment includes using the confidence score derived from conformal prediction to assess whether an alert should be generated. This reduces the occurrence of false positives (i.e., unnecessary alerts) and facilitates alerts being triggered when the system is confident that the detected drift is real and significant. For example, in one or more embodiments, such alerts are only triggered if the uncertainty level exceeds one or more designated thresholds, which can be adaptive and vary based at least in part on the model's typical behavior and the environment in which the model is deployed.

Each alert can contain actionable information to help the user and/or system administrator understand the drift. Such alert information can include, for example, specification of whether the detected drift is concept drift, data drift, or a combination of both. This can help the alert recipient understand whether the drift is caused by a change in the relationship between features and labels (e.g., concept drift) or a shift in the input data distribution (e.g., data drift). Such alert information can also include a severity score that reflects the magnitude of the drift. This score can be derived from the extent of the detected drift and the increase in prediction uncertainty. Such severity scores can be categorized, for example, into tiers. By way or illustration, a high severity tier can indicate a significant drift that requires immediate action (e.g., model recalibration or retraining), a moderate severity tier can indicate that the drift is noticeable but does not yet critically affect model performance, and as such, further monitoring can be recommended over immediate action. Further, a low severity tier can indicate minor drift that does not require immediate attention but can be tracked over time.

As also noted above, such alert information can additionally include a confidence level associated with the detected drift, which reflects the system's certainty that the detected drift is real and/or significant. This confidence level can be derived from the corresponding conformal prediction intervals and can be leveraged by the user to decide whether immediate action is necessary. Further, such confidence levels can also be categorized into tiers, similar to the severity scores described above.

Alert information can additionally include identification of one or more recommended actions based at least in part on the type of drift detected, the severity of the drift detected, and the confidence level of the drift. Such recommended actions can include, for example, urgent model recalibration or partial retraining (e.g., for high-severity, high-confidence drifts), monitoring the drift for further developments (e.g., for moderate-severity and/or low-confidence drifts), and/or adjusting one or more data preprocessing steps (for data drift) and/or feature recalibration (for concept drift).

Additionally, in one or more contexts and/or real-world applications, it is common for both concept drift and data drift to occur simultaneously, or for multiple drifts to develop over time. Accordingly, at least one embodiment can include intelligently prioritizing and managing multiple concurrent drifts, as further detailed below. For instance, such an embodiment can include ranking the multiple drifts by confidence level and/or severity to determine which drifts should be addressed first. High-confidence, high-severity drifts can be prioritized, while lower-confidence drifts may be delayed and/or deprioritized.

Also, in such an embodiment, alerts generated for the multiple drifts can be leveraged to assist in allocating resources efficiently. For instance, if several drifts are detected across different models or subsystems, such an embodiment can include providing insights into which drift(s) need immediate attention and which drift(s) can be handled later. One or more embodiments can also include integrating with one or more monitoring dashboards to display real-time alerts, confidence levels, and/or recommended actions. In such an embodiment, users can view the overall health of the corresponding model(s) and any active drifts, along with detailed information on each drift. Further, in at least one embodiment, alerts can be configured to send automated notifications via various communication channels (e.g., email, short message service (SM S), messaging platforms, etc.) to ensure that key stakeholders are immediately informed when drifts are detected.

By way merely of illustration, consider an example context involving a predictive maintenance model being used in a factory setting to predict machinery failures. In such an example, assume that a potential drift is detected in the relationship between certain sensor readings (e.g., temperature and vibration) and machine breakdowns. Accordingly, at least one embodiment can include identifying this detect drift as a high-severity concept drift with high confidence, indicating that the model's understanding of the relationship between temperature and failure rates has shifted. A confidence-aware alert can then be generated, wherein the alert suggests immediate recalibration of the model and/or partial retraining of the model using the most recent sensor data.

Additionally, in this example context, a moderate-severity data drift is detected with moderate confidence, indicating that the distribution of sensor data has shifted slightly. A confidence-aware alert can be generated, wherein the alert recommends monitoring this drift but not taking immediate action. In this scenario, the system prioritizes the high-confidence, high-severity drift, ensuring that the most critical issue is addressed first while continuing to monitor the less urgent data drift.

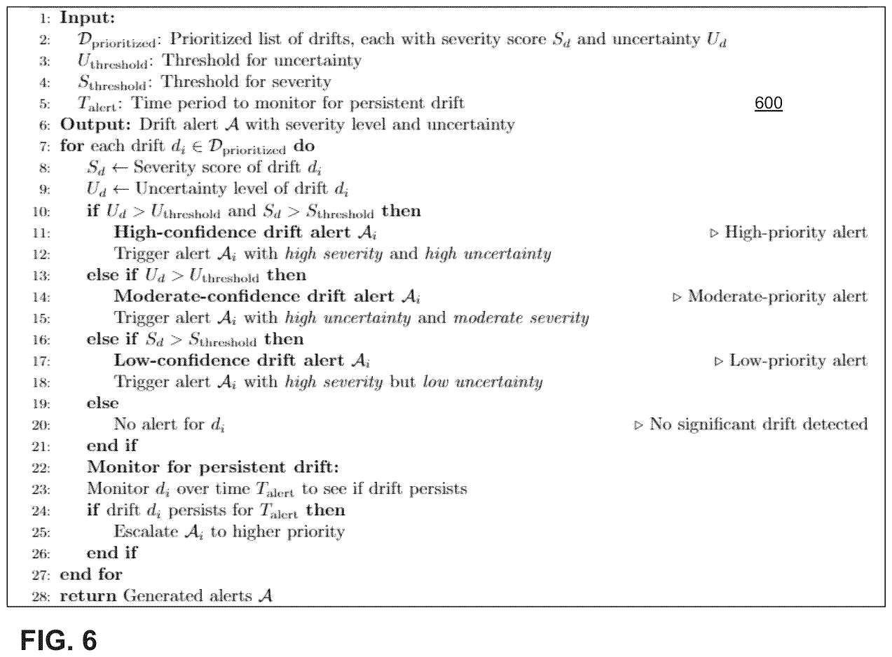

FIG. 6 shows example pseudocode for generating confidence-aware alerts in an illustrative embodiment. In this embodiment, example pseudocode 600 is executed by or under the control of at least one processing system and/or device. For example, the example pseudocode 600 may be viewed as comprising a portion of a software implementation of at least part of automated machine learning-based drift resolution system 105 of the FIG. 1 embodiment.

The example pseudocode 600 illustrates an algorithm for generating confidence-aware alerts based at least in part on the severity and uncertainty of the detected drift(s). Also, such alerts can be categorized into different confidence levels (e.g., high, moderate or low) depending on the drift characteristics, and at least one embodiment can additionally include monitoring whether the drift persists over time to potentially escalate the alert.

It is to be appreciated that this particular example pseudocode shows just one example implementation of generating confidence-aware alerts, and alternative implementations can be used in other embodiments.

As also detailed herein, one or more embodiments include performing post-intervention monitoring, which can include periodic and/or continuous evaluation of the effectiveness of any drift resolution actions taken. Additionally, such an embodiment can include monitoring the model's behavior post-intervention to reduce and/or prevent further performance degradation, as well as to fine-tune future drift detection and response strategies.

In monitoring one or more model performance metrics to assess whether the detected drift has been successfully mitigated, such performance metrics can include accuracy (e.g., determining whether the model's predictive accuracy improved or returned to its pre-drift levels), prediction uncertainty (e.g., determining whether the conformal prediction intervals narrowed, indicating that the model's confidence in its predictions has been restored), and/or one or more other domain-specific metrics (e.g., precision, recall, F1 score, etc.). Also, beyond immediate improvements, one or more embodiments can also include tracking whether model performance remains stable over a given period of time. For example, if metrics deteriorate again after the drift-related intervention(s), it may indicate that the drift was not fully addressed, requiring additional action.

Additionally, if a certain intervention (e.g., recalibration, partial retraining, etc.) is determined to have been successful for a particular type of drift (e.g., concept drift), at least one embodiment can include records this determination and prioritizing a similar resolution method or the same resolution method if a similar drift is detected for the model in the future.

Also, one or more embodiments can additionally include tracking how quickly the model recovers after each intervention, enabling refinement to the timing and intensity of future intervention actions. For example, if partial retraining resolves a data drift more quickly than full retraining, such an embodiment can include prioritizing partial retraining when similar drifts are detected. Further, over time, such an embodiment can include learning and/or recognizing one or more drift patterns (e.g., recurring data drifts during specific times, seasonal concept drifts, etc.) and can proactively suggest intervention strategies in accordance with such patterns.

Additionally, if post-intervention monitoring reveals that a drift was not fully resolved, at least one embodiment can include triggering one or more additional interventions. Such an embodiment can include, for example, escalating a given intervention action (e.g., moving from recalibration to partial retraining or from partial retraining to full retraining). Further, such an embodiment can include implementing one or more thresholds for initiating additional actions. For example, if model performance metrics remain below acceptable levels, or if prediction uncertainty continues to increase, such an embodiment can include identifying that the initial intervention was insufficient. In such cases, such an embodiment can include automatically escalating the resolution mechanism by applying a more intensive intervention (e.g., full retraining of the model). Also, one or more embodiments can include generating notifications pertaining to the outcomes of intervention actions via confidence-aware alerts.

By way merely of illustration, consider an example use case involving a fraud detection model being used by a bank to identify fraudulent transactions. After detecting a concept drift in customer behavior patterns, an example embodiment includes recalibrating the model to give more weight to certain transaction features. After the recalibration, such an embodiment includes monitoring the model's performance by tracking metrics such as, e.g., fraud detection accuracy, false positive rates, and prediction uncertainty, and monitoring if the recalibration successfully restored the model's predictive power. Assume, in this example, that such monitoring has determined that fraud detection accuracy has improved by 15%, and the prediction uncertainty has decreased, indicating that the concept drift has been effectively resolved and the recalibration intervention was successful. Further, such an embodiment includes recording this outcome to one or more data structures (e.g., machine learning model-related data structures 107), learning that recalibration is an effective intervention for this type of concept drift in the fraud detection model. As such, in the future, if similar drifts occur, such an embodiment can include prioritizing recalibration as a preferred intervention.

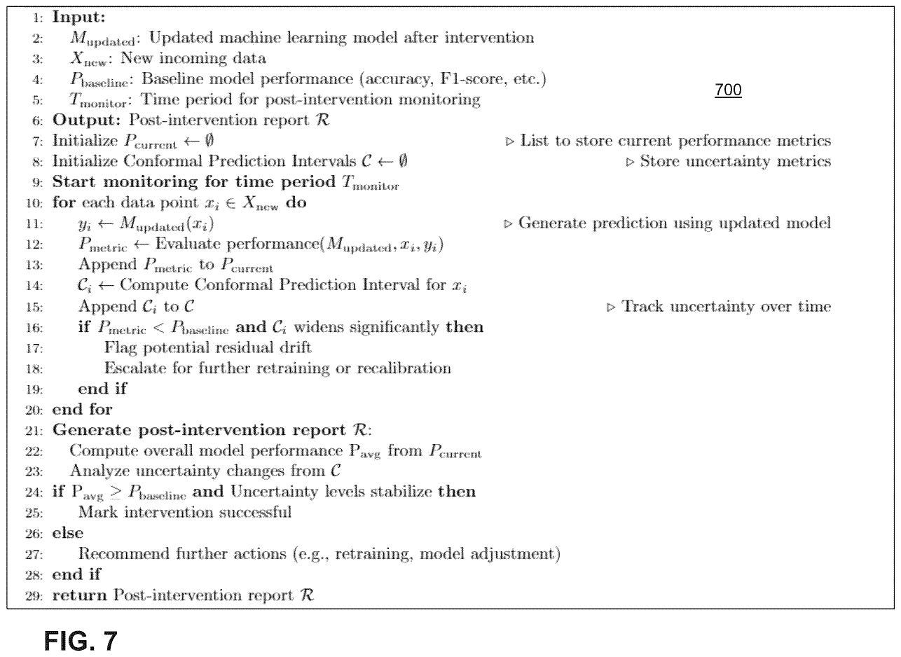

FIG. 7 shows example pseudocode for implementing post-intervention monitoring in an illustrative embodiment. In this embodiment, example pseudocode 700 is executed by or under the control of at least one processing system and/or device. For example, the example pseudocode 700 may be viewed as comprising a portion of a software implementation of at least part of automated machine learning-based drift resolution system 105 of the FIG. 1 embodiment.

The example pseudocode 700 illustrates an algorithm for implementing post-intervention monitoring, which includes monitoring a model's performance after a drift resolution intervention (e.g., recalibration, retraining) has been carried out. A goal of such monitoring is to determine whether the drift was effectively resolved and whether the model's performance is back to its baseline. If not, one or more further corrective actions are recommended. By continuously tracking the model's performance and uncertainty levels, one or more embodiments include ensuring that drifts are properly mitigated and that future drift detection and resolution strategies are refined based on monitored outcomes. Such a continuous feedback loop not only stabilizes model performance but can also improve adaptability and efficiency over time.

It is to be appreciated that this particular example pseudocode shows just one example implementation of post-intervention monitoring, and alternative implementations can be used in other embodiments.

Referring again to FIG. 2 and as also detailed herein, one or more embodiments include performing output generation, wherein final outputs, after successfully resolving detected drifts and stabilizing the model's performance, are generated and transmitted to one or more devices, data structures, and/or systems. Such an embodiment can include ensuring, for example, that high-confidence predictions are delivered to end users and/or downstream systems, and that all relevant stakeholders are informed of the status of the machine learning model in question and/or intervention actions being carried out in accordance therewith.

By way of example, after drift detection and resolution, at least one embodiment includes ensuring that the given machine learning model has returned to an expected level of performance, whereby the model generates predictions that are accurate and reliable, with confidence levels restored through one or more intervention actions. In connection therewith, such an embodiment can include creating a report summarizing the drift event, the one or more intervention actions taken, and the outcome of the post-intervention monitoring. Such a report can include, for example, information pertaining to the type of drift (e.g., concept drift or data drift), the severity of the drift and the confidence level associated with the detection, the one or more intervention actions taken (e.g., recalibration, partial retraining, full retraining, etc.), and post-intervention performance and uncertainty improvements. Further, such a report can serve as an audit trail and can be used in connection with regulatory compliance or future analysis of system performance.

Additionally, as further detailed herein, the insights and data gathered from post-intervention monitoring can integrated into a learning process of one or more embodiments, helping to improve future drift detection and response strategies.

FIG. 8 is a flow diagram of a process for enhancing machine learning performance using conformal prediction techniques in an illustrative embodiment. It is to be understood that this particular process is only an example, and additional or alternative processes can be carried out in other embodiments.

In this embodiment, the process includes steps 800 through 806. These steps are assumed to be performed by the automated machine learning-based drift resolution system 105 utilizing elements 112, 114 and 116.

Step 800 includes determining uncertainty associated with at least one machine learning-generated prediction by processing the at least one machine learning-generated prediction using one or more conformal prediction techniques. In at least one embodiment, determining uncertainty associated with at least one machine learning-generated prediction includes using the one or more conformal prediction techniques to generate at least one prediction interval sized in connection with the at least one machine learning-generated prediction, wherein the size of the at least one prediction interval corresponds to prediction uncertainty.

Step 802 includes detecting one or more of concept drift and data drift associated with the at least one machine learning-generated prediction based at least in part on the determined uncertainty. In one or more embodiments, detecting one or more of concept drift and data drift associated with the at least one machine learning-generated prediction includes detecting, using the determined uncertainty in connection with one or more statistical measures, at least one of one or more shifts in data distribution and one or more relationships between one or more input features and one or more target variables.

Step 804 includes modifying at least a portion of at least one machine learning model associated with the at least one machine learning-generated prediction based at least in part on detecting the one or more of concept drift and data drift. In at least one embodiment, modifying at least a portion of the at least one machine learning model includes performing, in response to detecting data drift associated with the at least one machine learning-generated prediction, one or more relationship-based adjustments in connection with the at least one machine learning model. Additionally or alternatively, modifying at least a portion of the at least one machine learning model can include performing, in response to detecting data drift associated with the at least one machine learning-generated prediction, recalibration of at least a portion of the at least one machine learning model.

Further, in at least one embodiment, modifying at least a portion of the at least one machine learning model includes performing, in response to detecting concept drift associated with the at least one machine learning-generated prediction, recalibration of at least a portion of the at least one machine learning model. Additionally or alternatively, modifying at least a portion of the at least one machine learning model comprises adjusting, in response to detecting concept drift associated with the at least one machine learning-generated prediction, one or more internal parameters of the at least one machine learning model comprising one or more of at least one model weight, at least one feature importance value, and one or more decision boundaries.

Also, in at least one embodiment, modifying at least a portion of the at least one machine learning model is further based at least in part on at least one severity level associated with the determined uncertainty.

Step 806 includes performing one or more automated actions in connection with automatically modifying the at least a portion of the at least one machine learning model. In one or more embodiments, performing one or more automated actions includes generating and outputting, to one or more devices associated with the at least one machine learning model, one or more confidence-aware alerts related to detecting the one or more of concept drift and data drift, wherein the one or more confidence-aware alerts identify detected drift type information, provide at least one confidence score associated with detecting the one or more of concept drift and data drift, and provide one or more actionable insights associated with detecting the one or more of concept drift and data drift. Additionally or alternatively, performing one or more automated actions can include automatically monitoring one or more performance metrics of the at least one machine learning model subsequent to automatically modifying the at least a portion of the at least one machine learning model.

Also, in at least one embodiment, performing one or more automated actions can include automatically outputting, to one or more devices, an updated version of the at least one machine learning-generated prediction generated subsequent to automatically modifying the at least a portion of the at least one machine learning model. Additionally or alternatively, performing one or more automated actions can include automatically retraining at least a portion of the at least one machine learning model using data not previously used for training the at least one machine learning model.

Accordingly, the particular processing operations and other functionality described in conjunction with the flow diagram of FIG. 8 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically adapt a machine learning model-generated response associated with drift detection based at least in part on the severity of the uncertainty as determined by a corresponding conformal prediction. These and other embodiments can effectively overcome problems associated with false positives, errors, and inefficient use of computing resources arising from the lack of mechanisms for quantifying uncertainty in model predictions.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

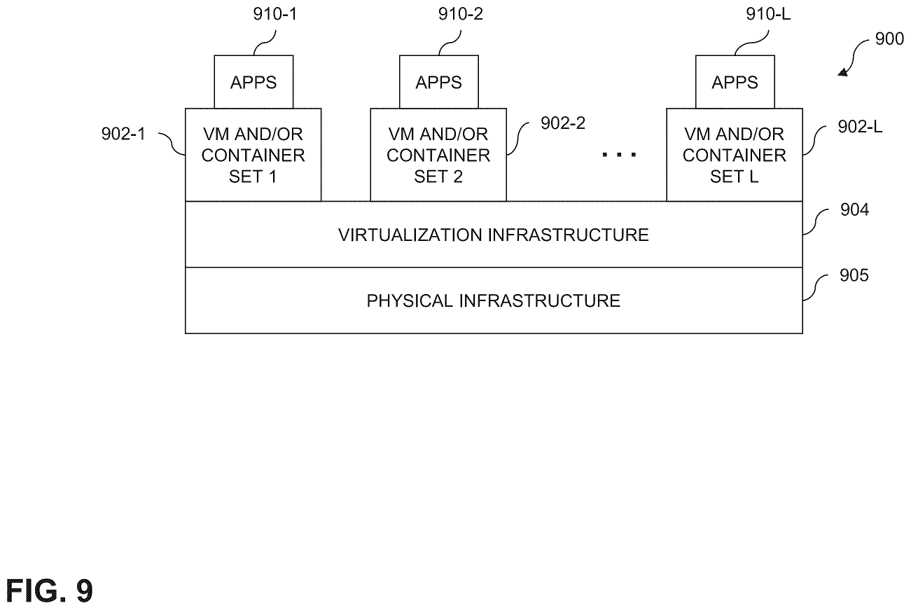

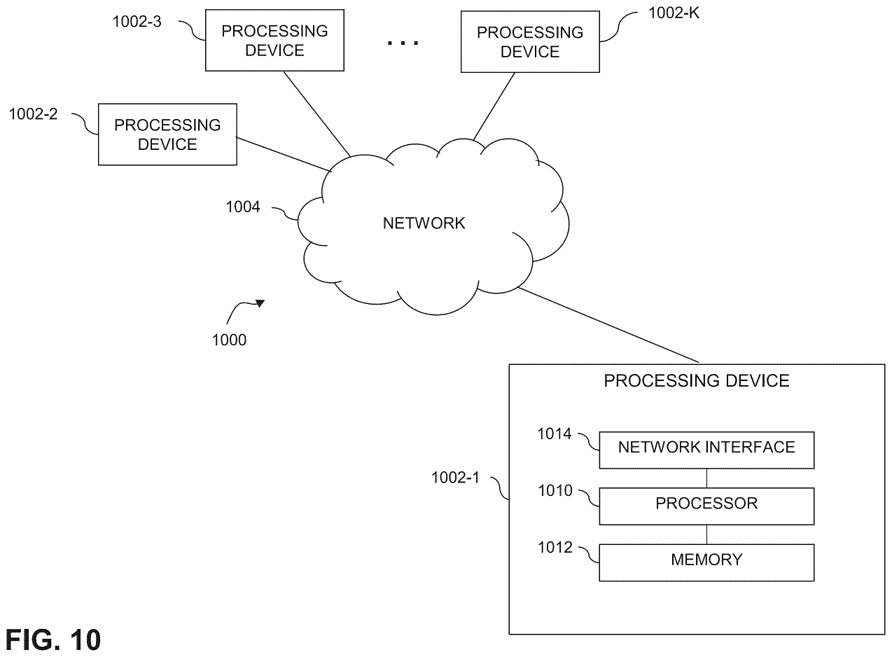

Illustrative embodiments of processing platforms will now be described in greater detail with reference to FIGS. 9 and 10. Although described in the context of system 100, these platforms may also be used to implement at least portions of other information processing systems in other embodiments.

FIG. 9 shows an example processing platform comprising cloud infrastructure 900. The cloud infrastructure 900 comprises a combination of physical and virtual processing resources that are utilized to implement at least a portion of the information processing system 100. The cloud infrastructure 900 comprises multiple virtual machines (VMs) and/or container sets 902-1, 902-2, . . . 902-L implemented using virtualization infrastructure 904. The virtualization infrastructure 904 runs on physical infrastructure 905, and illustratively comprises one or more hypervisors and/or operating system level virtualization infrastructure. The operating system level virtualization infrastructure illustratively comprises kernel control groups of a Linux operating system or other type of operating system.

The cloud infrastructure 900 further comprises sets of applications 910-1, 910-2, . . . 910-L running on respective ones of the VMs/container sets 902-1, 902-2, . . . 902-L under the control of the virtualization infrastructure 904. The VMs/container sets 902 comprise respective VMs, respective sets of one or more containers, or respective sets of one or more containers running in VMs. In some implementations of the FIG. 9 embodiment, the VMs/container sets 902 comprise respective VMs implemented using virtualization infrastructure 904 that comprises at least one hypervisor.

A hypervisor platform may be used to implement a hypervisor within the virtualization infrastructure 904, wherein the hypervisor platform has an associated virtual infrastructure management system. The underlying physical machines comprise one or more information processing platforms that include one or more storage systems.

In other implementations of the FIG. 9 embodiment, the V M s/container sets 902 comprise respective containers implemented using virtualization infrastructure 904 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 900 shown in FIG. 9 may represent at least a portion of one processing platform. Another example of such a processing platform is processing platform 1000 shown in FIG. 10.

The processing platform 1000 in this embodiment comprises a portion of system 100 and includes a plurality of processing devices, denoted 1002-1, 1002-2, 1002-3, . . . 1002-K, which communicate with one another over a network 1004.

The network 1004 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1002-1 in the processing platform 1000 comprises a processor 1010 coupled to a memory 1012.

The processor 1010 comprises a microprocessor, an A SIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory 1012 comprises RAM, ROM or other types of memory, in any combination. The memory 1012 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1002-1 is network interface circuitry 1014, which is used to interface the processing device with the network 1004 and other system components, and may comprise conventional transceivers.

The other processing devices 1002 of the processing platform 1000 are assumed to be configured in a manner similar to that shown for processing device 1002-1 in the figure.

A gain, the particular processing platform 1000 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LX Cs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

What is claimed is:

1. A computer-implemented method comprising:
determining uncertainty associated with at least one machine learning-generated prediction by processing the at least one machine learning-generated prediction using one or more conformal prediction techniques;
detecting one or more of concept drift and data drift associated with the at least one machine learning-generated prediction based at least in part on the determined uncertainty;
modifying at least a portion of at least one machine learning model associated with the at least one machine learning-generated prediction based at least in part on detecting the one or more of concept drift and data drift; and
performing one or more automated actions in connection with automatically modifying the at least a portion of the at least one machine learning model;
wherein the method is performed by at least one processing device comprising a processor coupled to a memory.

2. The computer-implemented method of claim 1, wherein determining uncertainty associated with at least one machine learning-generated prediction comprises using the one or more conformal prediction techniques to generate at least one prediction interval sized in connection with the at least one machine learning-generated prediction, wherein the size of the at least one prediction interval corresponds to prediction uncertainty.

3. The computer-implemented method of claim 1, wherein detecting one or more of concept drift and data drift associated with the at least one machine learning-generated prediction comprises detecting, using the determined uncertainty in connection with one or more statistical measures, at least one of one or more shifts in data distribution and one or more relationships between one or more input features and one or more target variables.

4. The computer-implemented method of claim 1, wherein performing one or more automated actions comprises generating and outputting, to one or more devices associated with the at least one machine learning model, one or more confidence-aware alerts related to detecting the one or more of concept drift and data drift, wherein the one or more confidence-aware alerts identify detected drift type information, provide at least one confidence score associated with detecting the one or more of concept drift and data drift, and provide one or more actionable insights associated with detecting the one or more of concept drift and data drift.

5. The computer-implemented method of claim 1, wherein modifying at least a portion of the at least one machine learning model comprises performing, in response to detecting data drift associated with the at least one machine learning-generated prediction, one or more relationship-based adjustments in connection with the at least one machine learning model.

6. The computer-implemented method of claim 1, wherein modifying at least a portion of the at least one machine learning model comprises performing, in response to detecting data drift associated with the at least one machine learning-generated prediction, recalibration of at least a portion of the at least one machine learning model.

7. The computer-implemented method of claim 1, wherein modifying at least a portion of the at least one machine learning model comprises performing, in response to detecting concept drift associated with the at least one machine learning-generated prediction, recalibration of at least a portion of the at least one machine learning model.

8. The computer-implemented method of claim 1, wherein modifying at least a portion of the at least one machine learning model comprises adjusting, in response to detecting concept drift associated with the at least one machine learning-generated prediction, one or more internal parameters of the at least one machine learning model comprising one or more of at least one model weight, at least one feature importance value, and one or more decision boundaries.

9. The computer-implemented method of claim 1, wherein modifying at least a portion of the at least one machine learning model is further based at least in part on at least one severity level associated with the determined uncertainty.

10. The computer-implemented method of claim 1, wherein performing one or more automated actions comprises automatically monitoring one or more performance metrics of the at least one machine learning model subsequent to automatically modifying the at least a portion of the at least one machine learning model.

11. The computer-implemented method of claim 1, wherein performing one or more automated actions comprises automatically outputting, to one or more devices, an updated version of the at least one machine learning-generated prediction generated subsequent to automatically modifying the at least a portion of the at least one machine learning model.

12. The computer-implemented method of claim 1, wherein performing one or more automated actions comprises automatically retraining at least a portion of the at least one machine learning model using data not previously used for training the at least one machine learning model.

13. A non-transitory processor-readable storage medium having stored therein program code of one or more software programs, wherein the program code when executed by at least one processing device causes the at least one processing device:
to determine uncertainty associated with at least one machine learning-generated prediction by processing the at least one machine learning-generated prediction using one or more conformal prediction techniques;
to detect one or more of concept drift and data drift associated with the at least one machine learning-generated prediction based at least in part on the determined uncertainty;
to modify at least a portion of at least one machine learning model associated with the at least one machine learning-generated prediction based at least in part on detecting the one or more of concept drift and data drift; and
to perform one or more automated actions in connection with automatically modifying the at least a portion of the at least one machine learning model.

14. The non-transitory processor-readable storage medium of claim 13, wherein determining uncertainty associated with at least one machine learning-generated prediction comprises using the one or more conformal prediction techniques to generate at least one prediction interval sized in connection with the at least one machine learning-generated prediction, wherein the size of the at least one prediction interval corresponds to prediction uncertainty.

15. The non-transitory processor-readable storage medium of claim 13, wherein detecting one or more of concept drift and data drift associated with the at least one machine learning-generated prediction comprises detecting, using the determined uncertainty in connection with one or more statistical measures, at least one of one or more shifts in data distribution and one or more relationships between one or more input features and one or more target variables.

16. The non-transitory processor-readable storage medium of claim 13, wherein performing one or more automated actions comprises generating and outputting, to one or more devices associated with the at least one machine learning model, one or more confidence-aware alerts related to detecting the one or more of concept drift and data drift, wherein the one or more confidence-aware alerts identify detected drift type information, provide at least one confidence score associated with detecting the one or more of concept drift and data drift, and provide one or more actionable insights associated with detecting the one or more of concept drift and data drift.

17. An apparatus comprising:
at least one processing device comprising a processor coupled to a memory;
the at least one processing device being configured:
to determine uncertainty associated with at least one machine learning-generated prediction by processing the at least one machine learning-generated prediction using one or more conformal prediction techniques;
to detect one or more of concept drift and data drift associated with the at least one machine learning-generated prediction based at least in part on the determined uncertainty;
to modify at least a portion of at least one machine learning model associated with the at least one machine learning-generated prediction based at least in part on detecting the one or more of concept drift and data drift; and
to perform one or more automated actions in connection with automatically modifying the at least a portion of the at least one machine learning model.

18. The apparatus of claim 17, wherein determining uncertainty associated with at least one machine learning-generated prediction comprises using the one or more conformal prediction techniques to generate at least one prediction interval sized in connection with the at least one machine learning-generated prediction, wherein the size of the at least one prediction interval corresponds to prediction uncertainty.

19. The apparatus of claim 17, wherein detecting one or more of concept drift and data drift associated with the at least one machine learning-generated prediction comprises detecting, using the determined uncertainty in connection with one or more statistical measures, at least one of one or more shifts in data distribution and one or more relationships between one or more input features and one or more target variables.

20. The apparatus of claim 17, wherein performing one or more automated actions comprises generating and outputting, to one or more devices associated with the at least one machine learning model, one or more confidence-aware alerts related to detecting the one or more of concept drift and data drift, wherein the one or more confidence-aware alerts identify detected drift type information, provide at least one confidence score associated with detecting the one or more of concept drift and data drift, and provide one or more actionable insights associated with detecting the one or more of concept drift and data drift.
